(19) United States
(12) Patent Application Publication
(10) Pub. No.: US 2026/0044429 A1
(43) Pub. Date: Feb. 12, 2026

(54) METHOD AND SYSTEM FOR PROVIDING AUTOMATED DATA CONTRACT MANAGEMENT

(71) Applicant: JPMorgan Chase Bank, N.A., New York, NY (US)

(72) Inventor: Shailesh SINGH, Frisco, TX (US)

(73) Assignee: JPMorgan Chase Bank, N.A., New York, NY (US)

(21) Appl. No.: 18/795,698

(22) Filed: Aug. 6, 2024

(51) Int. Cl. G06F 11/34; G06F 9/451

(52) U.S. Cl. CPC G06F 11/3438; G06F 9/451

(57) ABSTRACT

A method for providing automated data contract management in real-time at scale is disclosed. The method includes monitoring metrics for a plurality of applications to generate a corresponding report, the report including data artifacts for each of the plurality of applications; filtering the report based on predetermined criteria to generate a dependency mapping for the plurality of applications; determining versioning information for each of the plurality of applications based on the filtered report; identifying attribute information for each of the plurality of applications, the attribute information including deprecated attribute information and replacement attribute information; and generating, in real-time, a graphical user interface that visually represents the dependency mapping, the versioning information, and the attribute information for the plurality of applications, the graphical user interface including an interactive dashboard.

### BACKGROUND

### 1. Field of the Disclosure

This technology generally relates to methods and systems for managing data contracts, and more particularly to methods and systems for providing automated data contract management to facilitate dependency, versioning, and attribute administration at scale in real-time.

### 2. Background Information

Many business entities operate extensive application networks such as, for example, microservice architectures that are usable to provide services such as, for example, payment services for users. Often, these application networks rely on data in motion contracts to facilitate communication between publishing applications and consuming applications. Historically, implementations of conventional data contract management techniques have resulted in varying degrees of success with respect to effective versioning and dependency control of the applications at scale.

One drawback of implementing conventional data contract management techniques is that in many instances, application versions currently in use must be individually identified and data artifacts must be matched to each of the applications. As a result, mapping information related to the applications is resource intensive and ineffective at scale. Additionally, extracting real-time insight from the application networks may not be feasible due to the ineffective mapping of application information at scale across numerous different systems.

Therefore, there is a need for an automated data contract management system to facilitate dependency, versioning, and attribute administration at scale in real-time.

### SUMMARY

The present disclosure, through one or more of its various aspects, embodiments, and/or specific features or sub-components, provides, inter alia, various systems, servers, devices, methods, media, programs, and platforms for providing automated data contract management to facilitate dependency, versioning, and attribute administration at scale in real-time.

According to an aspect of the present disclosure, a method for providing automated data contract management in real-time at scale is disclosed. The method is implemented by at least one processor. The method may include monitoring at least one metric for each of a plurality of applications to generate a corresponding report, the report may include at least one data artifact for each of the plurality of applications; filtering the report based on at least one criterion to generate a dependency mapping for the plurality of applications; determining versioning information for each of the plurality of applications based on the filtered report; identifying attribute information for each of the plurality of applications, the attribute information may include deprecated attribute information and replacement attribute information; and generating, in real-time, a graphical user interface that visually represents the dependency mapping, the versioning information, and the attribute information for the plurality of applications, the graphical user interface may include an interactive dashboard.

In accordance with an exemplary embodiment, the method may further include identifying, by using the determined versioning information, at least one data contract that corresponds to each of the plurality of applications; determining, in real-time, a status for each of the plurality of applications based on the corresponding at least one data contract; and identifying, in real-time, at least one feature for each of the plurality of applications based on the corresponding at least one data contract.

In accordance with an exemplary embodiment, each of the at least one data contract may include an interdomain contract that facilitates data routing between autonomous systems, the status may include a development status that corresponds to a continuous integration and continuous deployment pipeline, and the at least one feature may correspond to a functionality for each of the plurality of applications in a software architecture.

In accordance with an exemplary embodiment, the method may further include identifying a characteristic for each of the plurality of application based on the dependency mapping, the versioning information, and the attribute information; validating, in real-time, each of the plurality of applications based on the identified characteristic and at least one corresponding data contract; and generating at least one notification based on a result of the validating.

In accordance with an exemplary embodiment, the characteristic may include a call characteristic that provides first information relating to requests for service processed by the plurality of applications, a schema characteristic that provides second information relating to a data processing model utilized by the plurality of applications, and a deprecated characteristic that provides third information relating to product support and recommended usage of the plurality of applications.

In accordance with an exemplary embodiment, the method may further include tracking, in real-time, at least one developmental milestone for each of the plurality of applications based on the dependency mapping, the versioning information, and the attribute information, wherein the at least one developmental milestone may correspond to a continuous integration and continuous deployment pipeline; and wherein the at least one developmental milestone may relate to a developmental epic that provides requirement information and task information from an end user perspective.

In accordance with an exemplary embodiment, the method may further include receiving at least one request from one of the plurality of applications, the at least one request may include an access request via a gateway; authorizing, in real-time, each of the at least one request based on the dependency mapping, the versioning information, and the attribute information; and enabling, via the gateway, access according to the at least one request based on a result of the authorizing.

In accordance with an exemplary embodiment, the method may further include tracking, in real-time, at least one dependency for each of the plurality of applications based on the dependency mapping, the versioning information, and the attribute information; and updating the graphical user interface based on the tracked at least one dependency.

In accordance with an exemplary embodiment, the graphical user interface may include at least one graphical element that visually represents data by using a color, a shape, and a symbol.

According to an aspect of the present disclosure, a computing device configured to implement an execution of a method for providing automated data contract management in real-time at scale is disclosed. The computing device including a processor; a memory; and a communication interface coupled to each of the processor and the memory, wherein the processor may be configured to monitor at least one metric for each of a plurality of applications to generate a corresponding report, the report may include at least one data artifact for each of the plurality of applications; filter the report based on at least one criterion to generate a dependency mapping for the plurality of applications; determine versioning information for each of the plurality of applications based on the filtered report; identify attribute information for each of the plurality of applications, the attribute information may include deprecated attribute information and replacement attribute information; and generate, in real-time, a graphical user interface that visually represents the dependency mapping, the versioning information, and the attribute information for the plurality of applications, the graphical user interface may include an interactive dashboard.

In accordance with an exemplary embodiment, the processor may be further configured to identify, by using the determined versioning information, at least one data contract that corresponds to each of the plurality of applications; determine, in real-time, a status for each of the plurality of applications based on the corresponding at least one data contract; and identify, in real-time, at least one feature for each of the plurality of applications based on the corresponding at least one data contract.

In accordance with an exemplary embodiment, each of the at least one data contract may include an interdomain contract that facilitates data routing between autonomous systems, the status may include a development status that corresponds to a continuous integration and continuous deployment pipeline, and the at least one feature corresponds to a functionality for each of the plurality of applications in a software architecture.

In accordance with an exemplary embodiment, the processor may be further configured to identify a characteristic for each of the plurality of application based on the dependency mapping, the versioning information, and the attribute information; validate, in real-time, each of the plurality of applications based on the identified characteristic and at least one corresponding data contract; and generate at least one notification based on a result of the validating.

In accordance with an exemplary embodiment, the characteristic may include a call characteristic that provides first information relating to requests for service processed by the plurality of applications, a schema characteristic that provides second information relating to a data processing model utilized by the plurality of applications, and a deprecated characteristic that provides third information relating to product support and recommended usage of the plurality of applications.

In accordance with an exemplary embodiment, the processor may be further configured to track, in real-time, at least one developmental milestone for each of the plurality of applications based on the dependency mapping, the versioning information, and the attribute information, wherein the at least one developmental milestone may correspond to a continuous integration and continuous deployment pipeline; and wherein the at least one developmental milestone may relate to a developmental epic that provides requirement information and task information from an end user perspective.

In accordance with an exemplary embodiment, the processor may be further configured to receive at least one request from one of the plurality of applications, the at least one request may include an access request via a gateway; authorize, in real-time, each of the at least one request based on the dependency mapping, the versioning information, and the attribute information; and enable, via the gateway, access according to the at least one request based on a result of the authorizing.

In accordance with an exemplary embodiment, the processor may be further configured to track, in real-time, at least one dependency for each of the plurality of applications based on the dependency mapping, the versioning information, and the attribute information; and update the graphical user interface based on the tracked at least one dependency.

In accordance with an exemplary embodiment, the graphical user interface may include at least one graphical element that visually represents data by using a color, a shape, and a symbol.

According to an aspect of the present disclosure, a non-transitory computer readable storage medium storing instructions for providing automated data contract management in real-time at scale is disclosed. The storage medium including executable code which, when executed by a processor, may cause the processor to monitor at least one metric for each of a plurality of applications to generate a corresponding report, the report may include at least one data artifact for each of the plurality of applications; filter the report based on at least one criterion to generate a dependency mapping for the plurality of applications; determine versioning information for each of the plurality of applications based on the filtered report; identify attribute information for each of the plurality of applications, the attribute information may include deprecated attribute information and replacement attribute information; and generate, in real-time, a graphical user interface that visually represents the dependency mapping, the versioning information, and the attribute information for the plurality of applications, the graphical user interface may include an interactive dashboard.

In accordance with an exemplary embodiment, when executed by the processor, the executable code may further cause the processor to identify, by using the determined versioning information, at least one data contract that corresponds to each of the plurality of applications; determine, in real-time, a status for each of the plurality of applications based on the corresponding at least one data contract; and identify, in real-time, at least one feature for each of the plurality of applications based on the corresponding at least one data contract.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing automated data contract management to facilitate dependency, versioning, and attribute administration at scale in real-time.

FIG. 4 is a flowchart of an exemplary process for implementing a method for providing automated data contract management to facilitate dependency, versioning, and attribute administration at scale in real-time.

FIG. 5 is a screen shot that illustrates a graphical user interface that is usable for implementing a method for providing automated data contract management to facilitate dependency, versioning, and attribute administration at scale in real-time, according to an exemplary embodiment.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

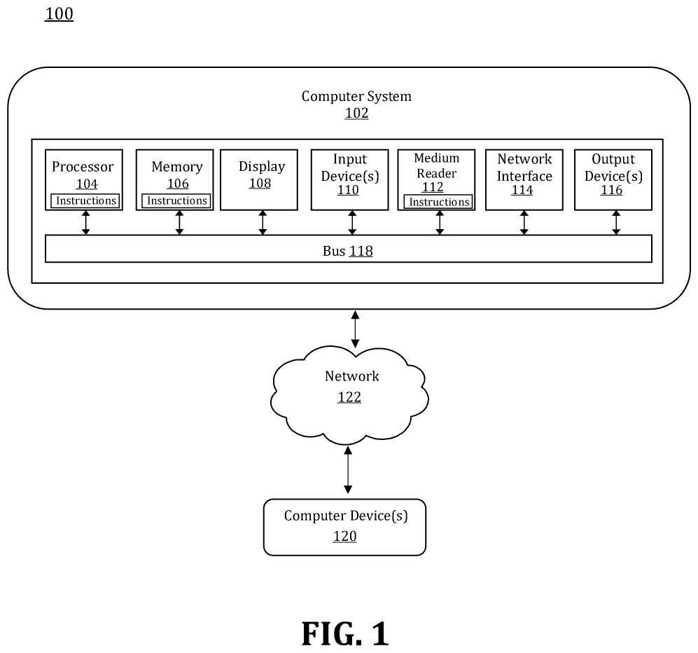

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing automated data contract management to facilitate dependency, versioning, and attribute administration at scale in real-time.

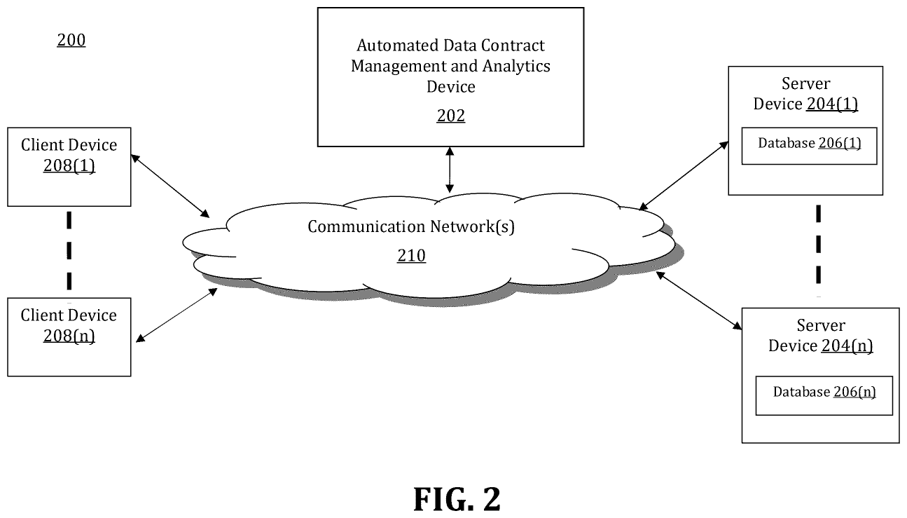

Referring to FIG. 2, a schematic of an exemplary network environment 200 for implementing a method for providing automated data contract management to facilitate dependency, versioning, and attribute administration at scale in real-time is illustrated. In an exemplary embodiment, the method is executable on any networked computer platform, such as, for example, a personal computer (PC).

The method for providing automated data contract management to facilitate dependency, versioning, and attribute administration at scale in real-time may be implemented by an Automated Data Contract Management and Analytics (ADCMA) device 202. The ADCMA device 202 may be the same or similar to the computer system 102 as described with respect to FIG. 1. The ADCMA device 202 may store one or more applications that can include executable instructions that, when executed by the ADCMA device 202, cause the ADCMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADCMA device 202 itself, may be located in virtual server(s) running in a cloud-based computing environment rather than being tied to one or more specific physical network computing devices. Also, the application(s) may be running in one or more virtual machines (VMs) executing on the ADCMA device 202. Additionally, in one or more embodiments of this technology, virtual machine(s) running on the ADCMA device 202 may be managed or supervised by a hypervisor.

In the network environment 200 of FIG. 2, the ADCMA device 202 is coupled to a plurality of server devices 204(1)-204(n) that hosts a plurality of databases 206(1)-206(n), and also to a plurality of client devices 208(1)-208(n) via communication network(s) 210. A communication interface of the ADCMA device 202, such as the network interface 114 of the computer system 102 of FIG. 1, operatively couples and communicates between the ADCMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADCMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ADCMA devices that efficiently implement a method for providing automated data contract management to facilitate dependency, versioning, and attribute administration at scale in real-time.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ADCMA device 202 may be a standalone device or integrated with one or more other devices or apparatuses, such as one or more of the server devices 204(1)-204(n), for example. In one particular example, the ADCMA device 202 may include or be hosted by one of the server devices 204(1)-204(n), and other arrangements are also possible. Moreover, one or more of the devices of the ADCMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ADCMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to application metrics, reports, data artifacts, dependency mappings, versioning information, and attribute information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ADCMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ADCMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ADCMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ADCMA device 202, the server devices 204(1)-204(n), or the client devices 208(1)-208(n), for example, may be configured to operate as virtual instances on the same physical machine. In other words, one or more of the ADCMA device 202, the server devices 204(1)-204(n), or the client devices 208(1)-208(n) may operate on the same physical device rather than as separate devices communicating through communication network(s) 210. Additionally, there may be more or fewer ADCMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

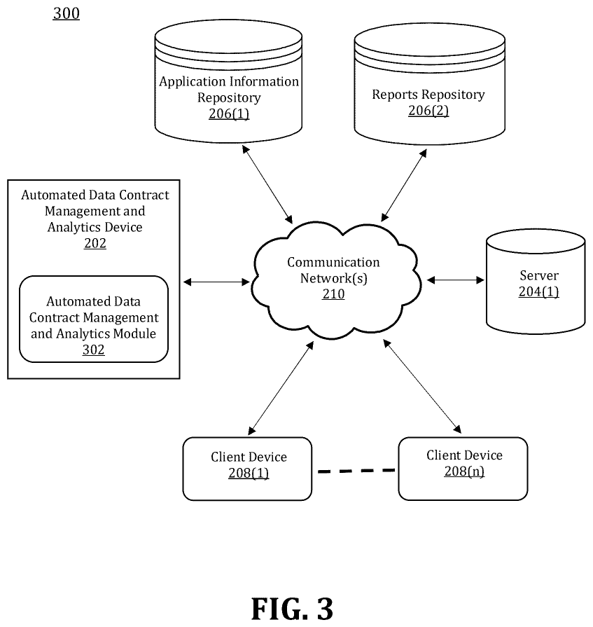

The ADCMA device 202 is described and shown in FIG. 3 as including an automated data contract management and analytics module 302, although it may include other rules, policies, modules, databases, or applications, for example. As will be described below, the automated data contract management and analytics module 302 is configured to implement a method for providing automated data contract management to facilitate dependency, versioning, and attribute administration at scale in real-time.

An exemplary process 300 for implementing a mechanism for providing automated data contract management to facilitate dependency, versioning, and attribute administration at scale in real-time by utilizing the network environment of FIG. 2 is shown as being executed in FIG. 3. Specifically, a first client device 208(1) and a second client device 208(2) are illustrated as being in communication with ADCMA device 202. In this regard, the first client device 208(1) and the second client device 208(2) may be “clients” of the ADCMA device 202 and are described herein as such. Nevertheless, it is to be known and understood that the first client device 208(1) and/or the second client device 208(2) need not necessarily be “clients” of the ADCMA device 202, or any entity described in association therewith herein. Any additional or alternative relationship may exist between either or both of the first client device 208(1) and the second client device 208(2) and the ADCMA device 202, or no relationship may exist.

Further, ADCMA device 202 is illustrated as being able to access an application information repository 206(1) and a reports repository 206(2). The automated data contract management and analytics module 302 may be configured to access these databases for implementing a method for providing automated data contract management to facilitate dependency, versioning, and attribute administration at scale in real-time.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ADCMA device 202 via broadband or cellular communication. Of course, these embodiments are merely exemplary and are not limiting or exhaustive.

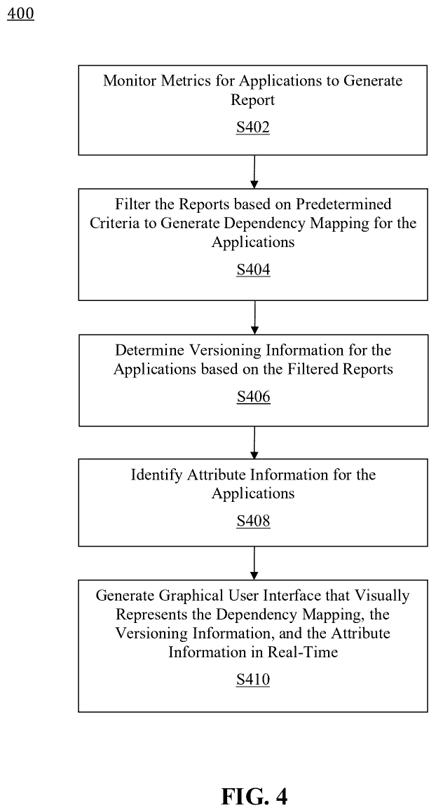

Upon being started, the automated data contract management and analytics module 302 executes a process for providing automated data contract management to facilitate dependency, versioning, and attribute administration at scale in real-time. An exemplary process for providing automated data contract management to facilitate dependency, versioning, and attribute administration at scale in real-time is generally indicated at flowchart 400 in FIG. 4.

In the process 400 of FIG. 4, at step S402, metrics may be monitored for each of a plurality of applications to generate a corresponding report. The metrics may provide information such as, for example, application dependency data relating to functionalities of the applications. In another example, the metrics may include data artifact information associated with the applications as well as version information about the applications. In an exemplary embodiment, the metrics may be obtained from a first-party source such as, for example, a monitoring system that is directly integrated with the disclosed invention. Conversely, the metrics may be obtained from a third-party source such as, for example, from an application scanner that outputs build information for applications in a development pipeline.

In another exemplary embodiment, the reports may include data artifacts for each of the applications. The reports may provide metrics of the data artifacts and versions currently used in each of the applications as well as latest versions available for each of the artifacts.

In another exemplary embodiment, the reports may be automatically generated based on a predetermined schedule as well as dynamically generated based on predetermined guidelines. The predetermined schedule may define a fixed period of time such as, for example, once a week when the report will be generated for the applications. The predetermined guidelines may define specific thresholds that, when satisfied, automatically triggers generation of the report for the applications. For example, the thresholds may relate to a development stage of the applications as well as a performance milestone of the applications.

In another exemplary embodiment, the applications may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, the reports may be filtered based on predetermined criteria to generate a dependency mapping for the applications. In an exemplary embodiment, the reports may be automatically retrieved for processing by the disclosed invention via a computing interface such as, for example, an application programming interface that facilitates interactions between various computing components. The reports may be processed in real-time by the disclosed invention as well as persisted for scheduled processing.

In another exemplary embodiment, the retrieved reports may be processed to extract dependency information for the applications. The dependency information may provide application publisher data as well as corresponding application subscriber data. To facilitate the data extraction, the reports may be automatically formatted into a compatible data format. The formatted reports may then be automatically parsed to identify the dependency information.

In another exemplary embodiment, the predetermined criteria may include filter parameters that are usable to facilitate identification of the dependency data from large quantities of data. The predetermined criteria may include identifiers in an alphanumeric format that distinguishes one application from another and/or one system from another. The predetermined criteria may be usable in a data filtering process that examines a dataset to exclude, rearrange, and/or apportion data according to the predetermined criteria.

At step S406, versioning information for each of the applications may be determined based on the filtered report. The versioning information may be determined in real-time consistent with present disclosures. The versioning information may be determined by comparing a current version for an application to a version that is required based on a predetermined guideline for a corresponding use case. For example, a current operating version for an application may be compared to a required operating version that is determined based on a functionality for a line of business.

In an exemplary embodiment, the versioning information may provide details related to usage of the data artifacts by the applications as well as a version of the used data artifacts. For example, the determining process may figure out which application is using what data artifacts and which versions to send and/or receive messages across an application network.

In another exemplary embodiment, the versioning information may be mapped to a listing of latest versions to facilitate a benchmarking of the applications. For example, the current versions in used by the applications may be compared to the benchmarking versions to identify outdated applications. In another exemplary embodiment, the versioning information may include a result of the benchmarking process. Consistent with present disclosures, the benchmarking process may be automatically completed in real-time without additional actions from a user.

At step S408, attribute information for each of the applications may be identified. The attribute information may be identified in real-time consistent with present disclosures. In an exemplary embodiment, the attribute information may correspond to data that determine properties of the applications. The attribute information may define desired properties of the applications. The attribute information may include deprecated attribute information and replacement attribute information. The deprecated attribute information may indicate that use of a particular application is allowed but discouraged due to certain qualities of the application. The replacement attribute information may indicate a suitable alternative for applications that have been deprecated.

In another exemplary embodiment, the attribute information may be predetermined based on governing guidelines. The predetermined attributes may be identified based on determined qualities of the applications. For example, the governing guidelines may require that outdated applications are associated with deprecated attribute information. In another exemplary embodiment, the attribute information may be appended to the corresponding applications as metadata. The appended attribute information may provide information that is necessary for schema evolution.

At step S410, a graphical user interface that visually represents the dependency mapping, the versioning information, and the attribute information may be generated for the applications. The graphical user interface may be generated in real-time consistent with present disclosures.

In an exemplary embodiment, the graphical user interface may enable a user to interact with the disclosed system to manage and consume data associated with the dependency mapping, the versioning information, and the attribute information. The graphical user interface may allow the user to interact with the data through graphical icons and visual indicators. The graphical user interface may include graphical elements that visually represents data by using a color, a shape, and/or a symbol. For example, current health of an application may be visually represented by using a color to indicate urgency. That is, a green color may indicate good health while a red color may indicate that further action is required.

In another exemplary embodiment, the graphical user interface may include an interactive dashboard. The interactive dashboard may correspond to a type of graphical user interface that provides at-a-glance views of data relevant to a particular objective and/or process through a combination of visualizations and summary information. The user may interact directly with the dashboard to gain insight from the presented information. For example, the user may filter data in the dashboard as well as select certain data fields to obtain additional information.

In another exemplary embodiment, as a first proposed implementation of the disclosed system, interdomain contracts may be managed in real-time. To facilitate management of the interdomain contracts, data contracts that correspond to each of the applications may be identified by using the determined versioning information. For example, the disclosed system may determine which data contracts corresponds with which version of the applications. Each of the data contracts may include an interdomain contract that facilitates data routing between autonomous systems.

Then, a status may be determined in real-time for each of the applications based on the corresponding data contracts. The status may include a development status that corresponds to a continuous integration and continuous deployment pipeline. For example, the development status of an application based on the data contracts may indicate whether a developer is ready to proceed to next steps in the development pipeline. Finally, features may be identified for each of the applications based on the corresponding data contract. The features may correspond to a functionality of the applications in a software architecture. For example, the features may indicate that an application belongs in a microservice network that handles user payments and that the application itself is responsible for processing payment card information.

In another exemplary embodiment, as a second proposed implementation of the disclosed system, data contract usage may be managed in real-time. To facilitate usage management, characteristics may be identified for each of the applications based on the dependency mapping, the versioning information, and the attribute information. The characteristics may include a call characteristic, a schema characteristic, and a deprecated characteristic.

The call characteristic may provide first information relating to requests for services that are processed by the applications. For example, the call characteristic may provide information relating to what calls are made to which microservice. The schema characteristic may provide second information relating to a data processing model utilized by the applications. For example, the schema characteristic may provide information relating to which schema the application belongs. The deprecated characteristic may provide third information relating to product support and recommended usage of the applications. For example, the deprecated characteristic may provide information relating to which applications are usable and which applications are no longer usable after a certain time.

Then, to further facilitate usage management, a validation of the applications may be implemented based on the identified characteristics. That is, each of the applications may be validated in real-time based on the identified characteristics and the corresponding data contracts. The validation may ensure that a deprecated application, as determined by the associated data artifact, is no longer used by any system. Finally, notifications may be generated based on a result of the validating. The notifications may be generated based on predetermined user preferences. For example, a user may set the dashboard to provide a notification and highlight applications that did not pass the validation process.

In another exemplary embodiment, as a third proposed implementation of the disclosed system, a software development pipeline may be managed in real-time. To facilitate management of the software development pipeline, developmental milestones may be tracked in real-time for each of the applications. The developmental milestones may be tracked based on the dependency mapping, the versioning information, and the attribute information. The developmental milestones may correspond to a continuous integration and continuous deployment pipeline. The developmental milestones may relate to a developmental epic that provides requirement information and task information from an end user perspective. That is, by using the dependency mapping, the versioning information, and the attribute information, the disclosed system may enable the tracking of development epics to facilitate portfolio parity and determine developer progress.

In another exemplary embodiment, as a fourth proposed implementation of the disclosed system, access to dependent applications may be managed in real-time. To facilitate access management, requests may be received from the applications. The requests may relate to an access request via a gateway. Then, the requests may be authorized in real-time based on the dependency mapping, the versioning information, and the attribute information. Authorizing of the requests may serve to block gates and limit exposure based on dependencies of the applications. For example, when an application is compromised, the authorizing process may be usable to identify dependencies, block gates, and prevent access to dependent applications to prevent additional compromises. Access may be enabled via the gateway according to the request based on a result of the authorizing.

In another exemplary embodiment, as a fifth proposed implementation of the disclosed system, dependency tracking may be managed in real-time. To facilitate dependency management, the dependencies may be tracked in real-time for each of the applications based on the dependency mapping, the versioning information, and the attribute information. Then, the graphical user interface may be updated based on the tracked dependencies. The real-time tracking of dependencies may provide insight into system operation and resiliency.

In another exemplary embodiment, processes disclosed in the present application may be implemented by using models to facilitate the management of large data sets. The models may relate to at least one from among a large language model, a deep learning model, a natural language processing model, a machine learning model, a mathematical model, a process model, and a data model. The models may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori Algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the large language model may relate to a trained deep-learning model that understands and generates text in a human-like fashion. The large language model may recognize, summarize, translate, predict, and generate various types of text as well as content based on knowledge gained from massive data sets. In another exemplary embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

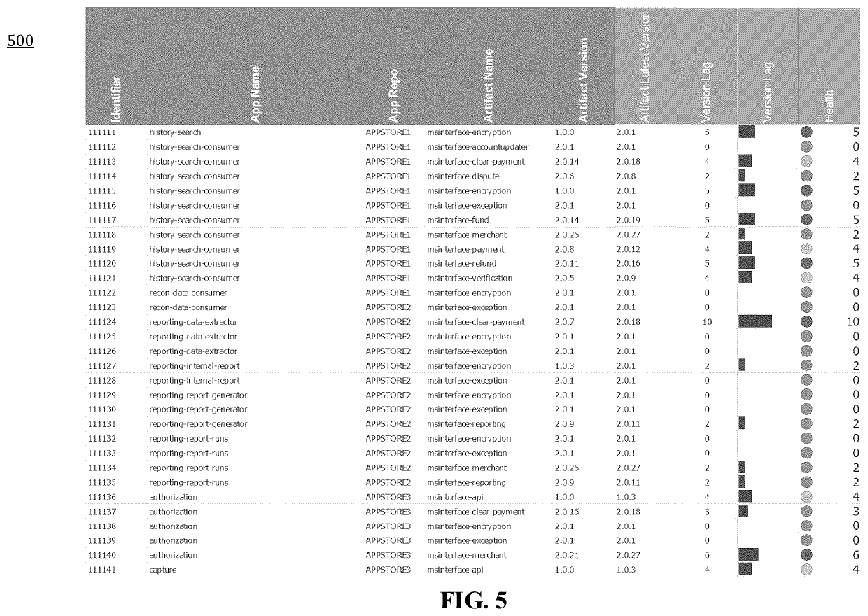

FIG. 5 is a screen shot 500 that illustrates a graphical user interface that is usable for implementing a method for providing automated data contract management to facilitate dependency, versioning, and attribute administration at scale in real-time, according to an exemplary embodiment. In FIG. 5, versioning information for various applications may be visually represented to provide insight into overall health of the applications.

As illustrated in FIG. 5, the versioning information my be presented in a table format. The applications may be identified and organized based on identifiers, application names, and application repositories. FIG. 5 also provides information relating to which artifact is associated with which applications together with the corresponding artifact version. Latest versions for the artifacts are provided consistent with present disclosures for comparison.

Based on the comparison, a version lag may be determined. Visual representations of the version lag such as, for example, as a rectangular bar may be generated based on the comparison. Similarly, visual representations of system health may be generated. For example, the visual representation of system health may use a color code to indicate current operability and need for attention.

Accordingly, with this technology, an optimized process for providing automated data contract management to facilitate dependency, versioning, and attribute administration at scale in real-time is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing automated data contract management in real-time at scale, the method being implemented by at least one processor, the method comprising:
monitoring, by the at least one processor, at least one metric for each of a plurality of applications to generate a corresponding report, the report including at least one data artifact for each of the plurality of applications;
filtering, by the at least one processor, the report based on at least one criterion to generate a dependency mapping for the plurality of applications;
determining, by the at least one processor, versioning information for each of the plurality of applications based on the filtered report;
identifying, by the at least one processor, attribute information for each of the plurality of applications, the attribute information including deprecated attribute information and replacement attribute information; and
generating, by the at least one processor in real-time, a graphical user interface that visually represents the dependency mapping, the versioning information, and the attribute information for the plurality of applications, the graphical user interface including an interactive dashboard.

2. The method of claim 1, further comprising:
identifying, by the at least one processor using the determined versioning information, at least one data contract that corresponds to each of the plurality of applications;
determining, by the at least one processor in real-time, a status for each of the plurality of applications based on the corresponding at least one data contract; and
identifying, by the at least one processor in real-time, at least one feature for each of the plurality of applications based on the corresponding at least one data contract.

3. The method of claim 2, wherein each of the at least one data contract includes an interdomain contract that facilitates data routing between autonomous systems;
wherein the status includes a development status that corresponds to a continuous integration and continuous deployment pipeline; and
wherein the at least one feature corresponds to a functionality for each of the plurality of applications in a software architecture.

4. The method of claim 1, further comprising:
identifying, by the at least one processor, a characteristic for each of the plurality of application based on the dependency mapping, the versioning information, and the attribute information;
validating, by the at least one processor in real-time, each of the plurality of applications based on the identified characteristic and at least one corresponding data contract; and
generating, by the at least one processor, at least one notification based on a result of the validating.

5. The method of claim 4, wherein the characteristic includes a call characteristic that provides first information relating to requests for service processed by the plurality of applications, a schema characteristic that provides second information relating to a data processing model utilized by the plurality of applications, and a deprecated characteristic that provides third information relating to product support and recommended usage of the plurality of applications.

6. The method of claim 1, further comprising:
tracking, by the at least one processor in real-time, at least one developmental milestone for each of the plurality of applications based on the dependency mapping, the versioning information, and the attribute information,
wherein the at least one developmental milestone corresponds to a continuous integration and continuous deployment pipeline; and
wherein the at least one developmental milestone relates to a developmental epic that provides requirement information and task information from an end user perspective.

7. The method of claim 1, further comprising:
receiving, by the at least one processor, at least one request from one of the plurality of applications, the at least one request including an access request via a gateway;
authorizing, by the at least one processor in real-time, each of the at least one request based on the dependency mapping, the versioning information, and the attribute information; and
enabling, by the at least one processor via the gateway, access according to the at least one request based on a result of the authorizing.

8. The method of claim 1, further comprising:
tracking, by the at least one processor in real-time, at least one dependency for each of the plurality of applications based on the dependency mapping, the versioning information, and the attribute information; and
updating, by the at least one processor, the graphical user interface based on the tracked at least one dependency.

9. The method of claim 1, wherein the graphical user interface includes at least one graphical element that visually represents data by using a color, a shape, and a symbol.

10. A computing device configured to implement an execution of a method for providing automated data contract management in real-time at scale, the computing device comprising:
a processor;
a memory; and
a communication interface coupled to each of the processor and the memory,
wherein the processor is configured to:
monitor at least one metric for each of a plurality of applications to generate a corresponding report, the report including at least one data artifact for each of the plurality of applications;
filter the report based on at least one criterion to generate a dependency mapping for the plurality of applications;
determine versioning information for each of the plurality of applications based on the filtered report;
identify attribute information for each of the plurality of applications, the attribute information including deprecated attribute information and replacement attribute information; and
generate, in real-time, a graphical user interface that visually represents the dependency mapping, the versioning information, and the attribute information for the plurality of applications, the graphical user interface including an interactive dashboard.

11. The computing device of claim 10, wherein the processor is further configured to:
identify, by using the determined versioning information, at least one data contract that corresponds to each of the plurality of applications;
determine, in real-time, a status for each of the plurality of applications based on the corresponding at least one data contract; and
identify, in real-time, at least one feature for each of the plurality of applications based on the corresponding at least one data contract.

12. The computing device of claim 11, wherein each of the at least one data contract includes an interdomain contract that facilitates data routing between autonomous systems;
wherein the status includes a development status that corresponds to a continuous integration and continuous deployment pipeline; and
wherein the at least one feature corresponds to a functionality for each of the plurality of applications in a software architecture.

13. The computing device of claim 10, wherein the processor is further configured to:
identify a characteristic for each of the plurality of application based on the dependency mapping, the versioning information, and the attribute information;
validate, in real-time, each of the plurality of applications based on the identified characteristic and at least one corresponding data contract; and
generate at least one notification based on a result of the validating.

14. The computing device of claim 13, wherein the characteristic includes a call characteristic that provides first information relating to requests for service processed by the plurality of applications, a schema characteristic that provides second information relating to a data processing model utilized by the plurality of applications, and a deprecated characteristic that provides third information relating to product support and recommended usage of the plurality of applications.

15. The computing device of claim 10, wherein the processor is further configured to:
track, in real-time, at least one developmental milestone for each of the plurality of applications based on the dependency mapping, the versioning information, and the attribute information,
wherein the at least one developmental milestone corresponds to a continuous integration and continuous deployment pipeline; and
wherein the at least one developmental milestone relates to a developmental epic that provides requirement information and task information from an end user perspective.

16. The computing device of claim 10, wherein the processor is further configured to:
receive at least one request from one of the plurality of applications, the at least one request including an access request via a gateway;
authorize, in real-time, each of the at least one request based on the dependency mapping, the versioning information, and the attribute information; and
enable, via the gateway, access according to the at least one request based on a result of the authorizing.

17. The computing device of claim 10, wherein the processor is further configured to:
track, in real-time, at least one dependency for each of the plurality of applications based on the dependency mapping, the versioning information, and the attribute information; and
update the graphical user interface based on the tracked at least one dependency.

18. The computing device of claim 10, wherein the graphical user interface includes at least one graphical element that visually represents data by using a color, a shape, and a symbol.

19. A non-transitory computer readable storage medium storing instructions for providing automated data contract management in real-time at scale, the storage medium comprising executable code which, when executed by a processor, causes the processor to:
monitor at least one metric for each of a plurality of applications to generate a corresponding report, the report including at least one data artifact for each of the plurality of applications;
filter the report based on at least one criterion to generate a dependency mapping for the plurality of applications;
determine versioning information for each of the plurality of applications based on the filtered report;
identify attribute information for each of the plurality of applications, the attribute information including deprecated attribute information and replacement attribute information; and
generate, in real-time, a graphical user interface that visually represents the dependency mapping, the versioning information, and the attribute information for the plurality of applications, the graphical user interface including an interactive dashboard.

20. The storage medium of claim 19, wherein, when executed by the processor, the executable code further causes the processor to:
identify, by using the determined versioning information, at least one data contract that corresponds to each of the plurality of applications;
determine, in real-time, a status for each of the plurality of applications based on the corresponding at least one data contract; and
identify, in real-time, at least one feature for each of the plurality of applications based on the corresponding at least one data contract.
